(19) United States
(12) Patent Application Publication
(10) Pub. No.: US 2005/0014591 A1
(43) Pub. Date: Jan. 20, 2005

(54) Toothed belt capable of indicating its life

(76) Inventors: Tatsuo Arai, Osaka (JP); Masato Tomobuchi, Osaka (JP); Hiroshi Kikuchi, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/858,790

(22) Filed: Jun. 2, 2004

(30) Foreign Application Priority Data
Jul. 16, 2003 (JP) 2003-275345

(51) Int. Cl. F16G 1/28; F16G 5/20; F16G 9/00

(52) U.S. Cl. 474/237; 474/250; 474/266

(57) ABSTRACT

A toothed belt, as commonly employed in power transmission and timing devices, is configured of distinctly colored components, especially in that the tooth cloth covering material and underlying rubber structural elements are colored distinctly from each other with non-black colors. The wear and tear of the toothed belt is revealed by a characteristic color appearance that arises due to abrasion, erosion, or deterioration of the toothed belt, and which can be readily assessed by visual inspection to provide an estimate of remaining useful operating life of the belt. Further, the construction of the toothed belt to provide a visual indication of its condition, does not compromise the durability of the toothed belt itself.

### FIELD OF INVENTION

The present invention relates generally to a toothed or notched belt, of the type used in industrial machinery and office automation equipment, vehicles, and power transmission and timing systems to convey torque forces on pulleys, axles, wheels, cogs, sprockets, and gears, or otherwise regulate the speed of rotating parts. The invention specifically relates to such toothed belts with structural features that provide a visible indication of the belts remaining useful operating life and degree of wear and tear.

### BACKGROUND

Toothed belts are commonly incorporated in many power transmission systems, as well as mechanical control and timing devices. Specific applications include industrial machinery; office automation equipment such as copiers, printers, scanners, fax machines, plotters and the like; heating, air conditioning, and ventilation equipment; vehicles such as automobiles, trucks, motorcycles, and bicycles; and various engines and motors. Typically, a belt is strapped around two or more rotating members such as pulleys, axles, wheels, cogs, sprockets, or gears. The belt is toothed or notched on surfaces which come into direct contact with the rotating member in order to give the belt better traction and prevent slippage. As the belt is made of a relatively soft, flexible material such as rubber, and is subjected to considerable forces and friction, the wear and damage to the belt is an important issue. Breakage of the belt, or less-than-optimal performance due to uneven wear, can be problematic and continued vigilance of belt integrity is needed as part of a preventive maintenance program. However, it is difficult to assess the condition of a conventional belt without interrupting the belt motion and making a close inspection of the belt, sometimes requiring the belt be removed from its mounting.

Toothed belts are usually composed of a belt body consisting of a carbon-black-containing rubber layer in which a plurality of core layers or wires are embedded along the longitudinal direction of the belt, a plurality of tooth portions are formed on the surface of the belt body, and a tooth covering or cloth covers a surface of the tooth portions. The tooth cloth may have anti-friction properties due to its material or materials of fabrication, and may also provide a self-lubrication function due to lubricated ingredients incorporated into the tooth cloth for such a purpose. When the tooth covering wears through, the belt exhibits tooth chipping or other kinds of abrasion, at which point the belt has reached the end of its useful operating life. As mentioned, this condition of wear is difficult to ascertain by ordinary visual inspection, especially when the belt is in motion and/or is stained or grimy.

Toothed belts in which the belt body and the tooth covering are fashioned of distinctly different colors in order to indicate visual wear are known, and are disclosed in Japanese Patent 2942459 (hereafter referred to as Reference 1) and Japanese Laid-Open Utility Model Registration No. Sho. 55-157143 (hereafter referred to as Reference 2).

In Reference 1, the tooth portions of the belt are coated with a tooth covering, which is impregnated with a coloring agent by immersing the tooth covering material in a solution of Resorcin-Formalin-Latex (RFL) containing inorganic pigments, the effect of which produces a tooth covering of some color other than black. Inorganic pigments produce tooth covering colors in various shades of white, gray, red, brown, yellow, green, and blue. In this case, the utility of the colored tooth cloth is based on the presumption that the appearance of black- or dark-colored regions in the tooth cloth are due to wear-through of the tooth cloth material and resultant exposure of the underlying black rubber material of the tooth portion or belt body. Thus, the color scheme of the black belt body and the colored tooth cover provides an inherent indicator of wear. However, as staining or blackening of the tooth cloth often occurs in normal operation, the appearance of black- or dark-colored regions on the tooth cloth may not be indicative of wear-through of the tooth cloth, but rather simply superficial discoloring or coating of the tooth cloth.

In a tooth belt disclosed in Reference 2, a contact surface of a tooth portion of the belt, in which said contact surface engages the rotating parts upon which the belt is strapped, is formed as a multilayer tooth cloth cover. Each component layer of the multilayered tooth cover can be colored distinctly and in a prescribed order, such that, for example, the top most layer is a specified color, the second layer from the top is another specified color, and so forth. In this way, the extent of wear and the presence of cracks in the tooth cover are revealed by the color displayed, which is indicative of the particular layer of the cloth that is exposed by wear or tear.

In the toothed belt disclosed in Reference 1, even if the colors of the tooth cloths are colors other than black, the rubber layer of the belt body is of a carbon black containing black color. Thus when the tooth cloth having a different color wears, the wear condition of the tooth cloth cannot be distinguished from a superficial black stain on the cover. Accordingly, it is difficult to judge the condition and remaining life of the toothed belt.

In regard to the toothed belt disclosed in Reference 2, it is difficult to judge the life of the toothed belt and the tooth cloth is a multilayer structure consisting of cotton cloths of different colors, there were problems related to the multilayer nature of the tooth cover in that the structure of the toothed belt becomes complicated and a wrinkle is liable to occur in the tooth cover and so the toothed belt has poor wear resistance.

### OBJECTS OF THE INVENTION

In view of the above mentioned limitations of the prior art represented by References 1 and 2, it is an object of the present invention to address these problems. More particularly, it is an object of the invention to provide a toothed belt that incorporates more reliable indicator features that allow one to visually assess the condition of the toothed belt with respect to its extent of wear and remaining operating life, and further, that such incorporated features do not compromise the durability of the toothed belt.

### DESCRIPTION OF THE INVENTION

The present invention is a toothed belt comprising a belt body consisting of a rubber layer in which a plurality of core wires are embedded and aligned along the longitudinal direction of the belt, a plurality of tooth portions formed on at least one surface of said belt body, and a tooth cloth cover formed over a surface of said tooth portions, and further characterized in that said rubber layer is colored with a pigment so that the rubber layer that comprises the belt body and tooth portions is a color other than black, and that said tooth cloth cover is also a color other than black, and moreover, that said tooth cloth is a color that is distinct from the color of the rubber layer. According to the present invention, the rubber belt body and its tooth portion are some non-black color, and at the same time, the tooth cloth covering is a color that is also non-black and is also distinct from the color of the belt body and its tooth portion. A consequence of these features is that when the tooth cloth wears away during operation of the belt, tooth portions are revealed by the appearance of a color characteristic of the belt body, which stands in contrast to the color of the tooth cloth. As the color characteristic of the belt body appears to varying extent, the degree of wear of the tooth cloth is indicated at a glance, and the remaining useful operating life of the toothed belt can be estimated. It can also be ascertained whether a surface portion the belt wears preferentially, or whether wear is skewed to one side of the belt. As a result, the condition of the toothed belt can be assessed, and corrective measures can be taken before the occurrence of tooth chipping.

### BRIEF DESCRIPTION OF FIGURE

FIG. 1 shows an example of the present invention by way of a partially cutout perspective of the toothed belt, some of the components of which are distinctly colored in order to provide a visible indicator of wear and tear.

### BEST MODE FOR PRACTICING THE INVENTION

According to the present invention, a toothed belt has a configuration comprised of a belt body rubber layer and a tooth cloth, both of which are colored differently from each other and neither of which is colored black, such that said coloring scheme enables the condition of the toothed belt to be judged by visual inspection.

### EXAMPLE OF THE INVENTION

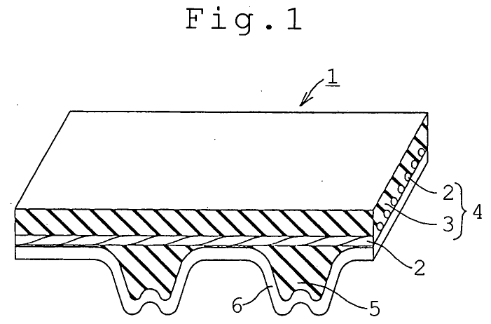

An example of the present invention will be described with reference to FIG. 1. FIG. 1 is a partial cut-out perspective of the toothed belt. The toothed belt 1 comprises a belt body 4 consisting of a rubber layer 3 in which a plurality of core wires 2 are embedded and aligned along the longitudinal direction of the belt, a plurality of tooth portions 5 formed on at least one surface of the belt body 4, and a tooth cloth covering at least some part of the surface of the tooth portions 5. The toothed belt may be made in such a manner that tooth portions are formed on both surfaces of the belt body 4.

The rubber layer 3, which forms said belt body 4 as well as tooth portions 5 is composed of a rubber that can be made mostly of a chloroprene polymer rubber(CR) as a main raw material. A blue pigment is contained in the rubber layer 3 as a coloring agent. As the rubber component, natural rubber (NR), chlorosulfonated polyethylene rubber (CSM), nitrile rubber (NB) or acrylonitrile butadiene rubber, hydrogenated nitrile rubber (H-NBR or HSN), polyisoprene rubber (IR), ethylene propylene rubber (EPR), polybutadiene rubber (BR), silicone rubber, and the like or blend thereof may also be used.

At least several coloring agents producing colors other than black or similar dark colors, are useful in the present invention and may include organic pigments such as phthalocianine blue, phthalocianine green, benzidine yellow, azo-pigment and the like, and inorganic pigments such as titanium oxide, aluminum hydroxide, calcium carbonate, zinc oxide, silica, clay, talc and the like. In this case, organic pigments having brighter color tone and larger coloring power as compared with inorganic pigments are preferably used.

The mixing amount of a coloring agent is preferably 0.1-10 weight parts per 100 weight parts of the rubber component. When the coloring agent is 0.1 weight parts or less per 100 weight part rubber component, sufficient color tone cannot be attained, but when it is in the range of 10 weight parts sufficient color tone can be attained. Using more coloring agent than 10 weight parts per 100 parts of rubber component may be used, but no appreciable change in the color tone is gained.

The core wire 2 is an aramid cord formed as a strand by twisting a plurality of spun yarns of aramide fiber, and immersing the strand into a solution of a Resorcin-Formalin-Latex (RFL) composition as an impregnation treatment. In this case, a pigment having an appropriate color may be contained in the RFL solution. For a core wire, a cord such as one selected from types known to be used as wires in toothed belts, and which include polyester cord, nylon cord, glass cord, steel cord or the like, may be also used.

In the tooth cloth 6, a twill fabric textile material with, for example, an ivory color is immersion-impregnated in an RFL composition solution, as for example, an RF solution Resorin-Formalin, NaOH, purified water) and an L solution (latex, ammonia, purified solvent). The cloth is then dried and the fabric so obtained is dipped in, or overspread with, a solution in which an organic peroxide cross-linking agent is dissolved in an organic solvent. Further, since the tooth cloth 6 is processed by treatment with a solution in which the organic peroxide cross-linking agent is dissolved in an organic solvent, a latex L of the RFL composition and the organic peroxide cross-linking agent act in combination, and as a result the tooth cloth 6 is strengthened by a cross-linked film. Accordingly, in the toothed belt 1 formed with such a tooth cloth 6, the durability, heat resistance and water resistance are enhanced.

With regard to the coloring of the tooth cloth 6, even if it was previously colored by dyeing or the like, or even if not intentionally colored, it is preferable to process the tooth cloth 6 while adding a color pigment to be colored to an RFL solution. In any case, the tooth cloth 6 is then colored, and the rubber layer 3 of toothed belt 1 is colored differently from the tooth cloth 6. For example, the rubber layer 3 and the tooth cloth 6 exhibit different colors by appropriately selecting their colors as blue, green, yellow, ivory, brown, pink, red etc.

The fabric textile material forming the tooth cloth 6 is woven with a filament yarn or a spun yarn of aramid fiber, nylon fiber, polyester fiber or the like, and a fabric, which is usually used in the tooth cloth of the toothed belt, such as twill fabric, as well as plain weave fabric or twilled silk weave fabric.

As a latex (L) component in said RFL composition, any latexes such as vinylpyridine (Vp) latex, H-NBR latex, NBR latex, CNBR latex, CH-NBR latex, SBR latex and the like, which take a cross-linking structure by reacting with an organic peroxide cross-linking agent, may be used. In this case, the latex is appropriately selected by adaptability to the rubber layer and necessary or desired properties.

The mass ratio of resorcinol, which is a condensation product of resorcin and formalin that comprise the RFL solution, to latex (L) influences the physical properties significantly. The mass ratio of and formalin (RF), the solid constituents of the RFL mixture, to that of latex (L) is preferably 1 part RF to a range of 5 to 15 parts of L. If there are less than 5 parts of L to RF in the formulation, the tooth cloth becomes excessively hard and brittle, and furthermore, the noise of the toothed belt is increased as is the chance of molding failure. On the other hand, if the ratio of parts of L to parts of RF exceeds 15, the tooth cloth becomes excessively soft, and exhibits a reduced adhesion whereby the wear resistance of the cloth is lowered, and adhesion to a rubber component, such as the belt body, is reduced.

As described above, the tooth cloth 6 was made by immersing a fabric in an RFL solution as an impregnation treatment. In this case, the amount of adhesion of the RFL solution, which adheres to the textile material, or the mass ratio of the textile material to the amount of the RFL solution adhered to the impregnated textile material, is preferably in the ratio of 1 part of the textile fabric to a range of 0.05-0.4 parts of the RFL solution. If the mass ratio is less than 0.05, adhesion to a rubber layer becomes short and wear resistance of the tooth portions worsens. On the other hand, if the adhesion mass ratio exceeds 0.4, the tooth cloth becomes excessively hard, which leads less than desirable belt properties that cause molding failure or the like.

The tooth cloth subjected to impregnation treatment with the RFL solution as described above is dipped into a solution in which an organic peroxide cross-linking agent is dissolved in an organic solvent, or alternatively, the solution is spread on the tooth cloth. For this organic peroxide cross-linking agent, any agent of diacyl peroxide type, peroxiester type, dialkyl peroxide type, or perketal type may be used. However, in consideration of workability, safety, and quality, dicumyl peroxide, di-t-butyl peroxide, t-butyl cumyl peroxide, 1.1-di-t-butyl peroxy-3.3.5-trimethyl cyclohexene, 2.5-dimethyl-2.5-di(t-butyl peroxy) hexane, 2.5-dimethyl-2.5-di(t-butyl peroxy) hexane-3, bis(t-butyl peroxy di-isopropyl) benzene, 2.5-dimethyl-2.5-di(benzoyl peroxy) hexane, t-butyl peroxy benzoate, t-butyl peroxy 2-ethyl-hexil carbonate and the like are preferred. Further, as the organic solvent, ether, ethanol, acetone and the like, which can dissolve an organic peroxide cross-linking agent, are used appropriately.

The adhered amount of the organic peroxide cross-linking agent, i.e., organic compounds with an -oxygen-oxygen-(—O—O—) functional group, is preferably in the range of 0.0006-0.009 grams of organic peroxide agent per 1 gram mass of latex (L) of the RFL solution. If the adhered amount is less than 0.0006 gram per 1 gram mass of latex, the cross-linking of the latex (L) is insufficient and wear resistance of the RFL film is decreased. Further, its bloating tendency for water and oil is increased, and temperature dependency is increased, which is undesirable. On the other hand, if the adhered amount exceeds 0.009 gram per gram of latex, the latex is excessively cured and the RFL itself becomes brittle to generate tension in the tooth cloth, resulting in reduced strength, bending fatigue resistance, and moldability.

The toothed belt is manufactured as follows. An ivory-colored tooth cloth is wound around the outer surface of a cylindrical mold having a tooth portion-forming groove so that a cross-linking film is on the cylindrical mold side, and a core wire is wound around the tooth cloth 6 at a fixed tension in a spiral fashion. Further, around the core wire is wound a blue non-vulcanized rubber sheet consisting of a rubber component, which is formed as a rubber layer. Then the obtained product is placed into a vulcanizer and pressed it from the outer peripheral side, and then it is heated by vapor. The toothed belt 1 is made by softening the rubber by the pressing and heating to form tooth portions 5, adhering a tooth cloth 6 the surface side of the tooth portions 5 and vulcanizing the rubber. In the thus manufactured toothed belt 1, the belt body 4 is colored blue and the surfaces of the tooth portions 5 are coated with the tooth cloth colored ivory.

It is noted that when a toothed belt is manufactured as a double side toothed belt in which toothed portions are formed on both sides of the belt, tooth cloths are wound around the outside of the non-vulcanized rubber sheet in the tooth cloths in an overlapping fashion, the obtained product is placed into a vulcanizer and heat-molded to form tooth portions on one side, after which the toothed belt is taken out and is wound between two pulleys and tooth portions are formed on the other side with a pressing mold or the like to molding vulcanize.

In the manufactured toothed belt 1 as described above, the belt body 2 is colored in blue and the surface of the tooth portion 5 coated with the tooth cloth 6 is of some color other than black, in the present case, ivory. Accordingly, when the tooth cloth 6 wears during use, the tooth portion 5 is exposed. Consequently, the wear conditions of the belt can be visually observed and the life of the toothed belt 1 can be easily judged. In this case it can be easily judged whether a tooth bottom portion of the toothed belt 1 wears, a surface portion thereof wears or wear on one side is generated or the like. Further, since the rubber layer 3 is colored in bright, fresh blue, even if the toothed belt 1 becomes dark by being soiled, discolored, covered with a grime or the like, the wear conditions of the toothed belt 1 is indicated and can be easily visually recognized or observed. As a result the life of the toothed belt 1 can be known and measures can be taken against the belt 1 before generation of tooth chipping by the wear of the tooth cloth. Further when the tooth cloth 6 is processed by the solution in which the organic peroxide cross-linking agent is dissolved in the organic solvent, a latex L of the RFL composition and the organic peroxide cross-linking agent are acted with each other and the tooth cloth 6 can be strengthened by a cross-linked film. In this way, the toothed belt is improved with respect to its durability, heat resistance, and water resistance.

1. A toothed belt comprising a belt body consisting of a rubber layer in which a plurality of core wires are embedded and aligned along the longitudinal direction of the belt, a plurality of tooth portions formed on at least one surface of said belt body, and a tooth cloth covering the surface of said tooth portions, and further characterized in that
said rubber layer contains a pigment such that the rubber layer that comprises the belt body and tooth portions is a color other than black, and said tooth cloth has a coloring other than black and that is distinct from the color of the rubber layer; and
whereby wear and tear of the tooth cover in particular and the tooth belt in general are indicated by the appearance and contrast of colored regions of the toothed belt that result from abrasion, erosion, or deterioration of toothed belt components.

2. A toothed belt according to claim 1 wherein said coloring other than black is selected from the group consisting of blue, green, yellow, ivory, brown, pink, and red.
